(19) United States
(12) Patent Application Publication
(10) Pub. No.: US 2005/0117227 A1
(43) Pub. Date: Jun. 2, 2005

(54) Panoramic imaging system with optical zoom capability

(76) Inventors: Ehud Gal, Reut (IL); Gennadiy Liteyga, Ashkelon (IL); Reuven Eyal, Ramat HaSharon (IL); Gil Graisman, Reut (IL)

Correspondence Address: LADAS & PARRY, 26 WEST 61ST STREET, NEW YORK, NY, 10023, US

(21) Appl. No.: 10/489,698

(22) PCT Filed:
(86) PCT No.: PCT/IL02/00768

Related U.S. Application Data
(60) Provisional application No. 60/322,737, filed on Sep. 18, 2001.

(51) Int. Cl. G02B 13/06

(52) U.S. Cl. 359/725

(57) ABSTRACT

An imaging assembly comprises a first, essentially symmetric reflective surface, having a shape suitable to reflect a substantially panoramic view of an area surrounding it, and a second reflective surface, which is asymmetric with respect to said first reflective surface, viz., which is positioned, with respect to the axis of symmetry of said first reflective surface, such that its movement in one or more directions reflects different portions of the area reflected by said first reflective surface, and the optical properties of said second reflective surface are such that area imaged by it is magnified with respect to the same portion of the area imaged by the first reflective surface.

### FIELD OF THE INVENTION

The present invention relates to the field of panoramic imaging. More particularly, the invention relates to a panoramic imaging system provided with optical zoom capabilities. More specifically, it relates to optical structures that enable the simultaneous imaging of up to a cylindrical field of view with additional optically zoomed sector, using a single image capturing device.

### BACKGROUND OF THE INVENTION

The imaging of a large field of view, specifically panoramic field of view, using a single image capture device, has many applications in the fields of medical imaging, security, monitoring, entertainment, industry, and many others. Current methods, which provide the coverage of a panoramic field of view simultaneously, do not support optical zoom on a sector of interest—an essential task in all applications.

The most common panoramic imaging systems are based on the use of an axis-symmetric reflective surface directed at an image capture device. Such systems are commercially available, and described, for example, in U.S. Pat. No. 6,157,018. According to said patent, the axis-symmetric reflective surface reflects a panoramic field of view toward an image-capture device, which is positioned coaxially with it. Due to the axisymmetric shape of the reflective surface, the image that is captured by the image capture device has the shape of a circle and contains the reflection of the panoramic field of view. The center of the circular image contains the reflection of the image capture device itself. The distorted image that is captured by the image capture device is usually modified and corrected using image processing techniques, which transform the image into a rectangular shape, suitable for convenient viewing. The center of the circular image, containing the reflection of the image-capture device, is not included as part of the final image since it does not contain any valuable data.

Notwithstanding the importance of providing such ability, no commercial device has been provided in the art to meet the long-felt need of zooming capabilities coupled with panoramic view. It is therefore an object of the present invention to provide such device which provides zooming capabilities coupled with a panoramic image-capture system.

It is another object of the invention to provide a method for generating a zoomed image of a portion of a panoramic image.

It is yet another object of the invention to provide a plurality of optical arrangements and devices suitable to carry out the invention.

Other objects and advantages of the invention will become apparent as the description proceeds.

### SUMMARY OF THE INVENTION

All panoramic imaging systems, which are based on the use of a reflective surface, produce an image of a well-defined shape, e.g., circular shape, with its center containing the reflection of the image capture device. As previously mentioned, that area of the image is not used for the creation of the final image. The present invention makes use of that area of the image to include an optically zoomed sector.

The invention is directed to an imaging assembly comprising a first, essentially symmetric reflective surface, having a shape suitable to reflect a substantially panoramic view of an area surrounding it, and a second reflective surface, which is asymmetric with respect to said first reflective surface, viz., which is positioned, with respect to the axis of symmetry of said first reflective surface, such that its movement in one or more directions reflects different portions of the area reflected by said first reflective surface, wherein the optical properties of said second reflective surface are such that area imaged by it is magnified with respect to the same portion of the area imaged by the first reflective surface.

According to a preferred embodiment of the invention the imaging assembly comprises:
A first convex reflective surface having a vertical axis of symmetry; and
A second reflective surface, having a first edge and a second edge, located around said vertical axis of symmetry of said first convex reflective surface, having a tilted position in respect to said vertical axis of symmetry of said first convex reflective surface, said second reflective surface having a radius of curvature different from the radius of curvature of said first convex reflective surface;
wherein light from a first 360 degrees panoramic scene is reflected by said first convex reflective surface, and light from a second scene is reflected by said second reflective surface.

The imaging assembly may further comprise an image capture device, directed toward said first convex reflective surface. In one preferred embodiment of the invention, the image capture device has an optical axis coinciding with the vertical axis of symmetry of said first convex reflective surface, said image capture device being set to capture the entire image that is reflected from said first convex reflective surface and the entire image that is reflected from said second reflective surface.

In another preferred embodiment of the invention the image capture device has an optical axis which is parallel to the vertical axis of symmetry of said first convex reflective surface, said image capture device being set to capture a part of the image that is reflected from said first convex reflective surface and the entire image that is reflected from said second reflective surface.

The imaging assembly of the invention may further comprise a connector having a first edge connected to said first convex reflective surface, and a second edge connected to said image-capture device, wherein optical transparency exists between said first edge and said second edge, allowing light arriving from the direction of said first edge to reach said image-capture device essentially without distortion.

According to a preferred embodiment of the invention the first edge of the second reflective surface is connected to the first convex reflective surface.

For instance, in the imaging assembly of the invention a hole is formed around the vertical axis of symmetry of the first convex reflective surface.

For certain embodiments of the invention it is desirable to provide a motor, located at the concave side of the first convex reflective surface, connected to the second reflective surface, through said hole.

The motor can be designed to control the rotation of the second reflective surface, or the depression and elevation of the second reflective surface, or the rotation of the imaging assembly, or two or more of said motions.

In a preferred embodiment of the invention the second reflective surface referred to above is located at the concave side of the first convex reflective surface, directed to reflect a second scene through said hole.

According to a preferred embodiment of the invention the imaging assembly further comprises an optical assembly, designed to control the magnification factor of the second scene, said optical assembly incorporating the second reflective surface and optical lenses. Said optical lenses can be located, e.g., between said second reflective surface and said second scene, or between said second reflective surface and said hole.

According to another preferred embodiment of the invention the imaging assembly is a monolithic lens in which the second reflective surface, which is asymmetric with respect to the first reflective surface, is integral with said first, essentially symmetric reflective surface, such that the rotation of said first reflective surface around its axis of symmetry causes said second reflective surface to reflect different portions of the area reflected by said first reflective surface.

In an alternative embodiment the second reflective surface extends into the monolithic lens through its upper surface and has a radius of curvature different from the radius of curvature of said upper surface, and said second reflective surface is coated with reflective material from its exterior.

In still another preferred embodiment of the invention an axisymmetric transparent refractive surface is provided in the first reflective surface around its axis of symmetry, said imaging assembly further comprising a third reflective surface suitable to reflect the panoramic image, which is reflected toward it by the first reflective surface, toward said axisymmetric transparent refractive surface.

In yet another preferred embodiment of the invention the second reflective surface which extends out from the third reflective surface is coated with reflective material from its exterior, and is set to reflect an image toward said axisymmetric transparent refractive surface.

All the above and other characteristics and advantages of the invention will be better understood through the following illustrative and non-limitative description of preferred embodiments thereof.

### BRIEF DESCRIPTION OF THE DRAWINGS

In the drawings:

FIG. 1A is an example of an image that is captured by a conventional panoramic imaging system;

FIG. 1B is the image of FIG. 1A after it has been transformed to a rectangular shape by conventional image processing techniques commonly employed in the art;

FIG. 2 shows an image that has been captured and produced by a panoramic imaging systems with optical zoom capability, according to a preferred embodiment of the present invention;

FIG. 3 is a schematic representation of a panoramic imaging system with optical zoom capability, according to one specific preferred embodiment of the invention;

FIG. 4 is a schematic representation of a panoramic lens with optical zoom capability at various azimuth and elevation angles, according to another preferred embodiment of the invention;

FIG. 5 is a schematic representation of an optical assembly which enables panoramic coverage with enhanced optical zoom capability, according to still another preferred embodiment of the invention;

FIG. 6 schematically illustrates a monolithic panoramic lens provides an inner optical zoom lens, according to still another preferred embodiment of the invention;

FIG. 7 schematically illustrates another monolithic panoramic lens which incorporates an optical zoom lens from within, according to a different preferred embodiment of the invention; and

FIG. 8 illustrates a method of capturing an almost panoramic image with enhanced resolution and optical zoom capability.

### DETAILED DESCRIPTION OF THE INVENTION

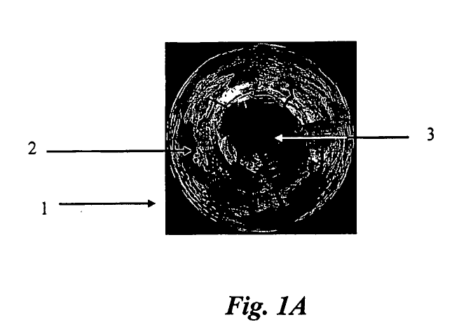

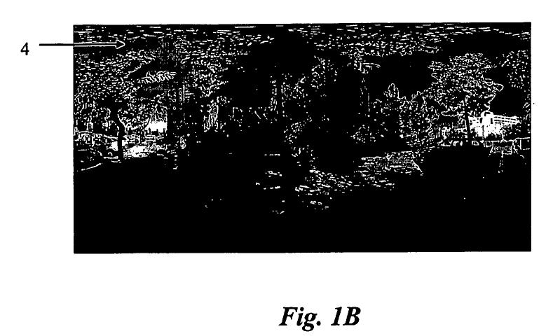

FIG. 1A shows the shape of an image that was acquired by a conventional panoramic imaging system. Such panoramic imaging system is based on the use of an axisymmetric reflective surface, which reflects a panoramic field of view towards an image capture device, which is located coaxially with it. Such systems are well known to the skilled person and, therefore, are not discussed herein in detail, for the sake of brevity.

In FIG. 1A a circular image, generally indicated by numeral 1, is acquired by the focal plane array of the image capture device. Since most common focal plane arrays are rectangular, the circular image usually does not occupy the entire area of the focal plane array. The circular image consists of two areas, an outer area (2) and an inner area (3). The outer area (2) contains the image of the panoramic field of view, as reflected from the axisymmetric reflective surface. The inner area (3) contains the image of the image capture device itself, as reflected from the axisymmetric reflective surface. The circular shape of the image (1) is actually a distortion of the real scene and it is unsuitable for simple viewing. Therefore, image processing techniques are used to convert the image (1) to the rectangular shape (4) shown in FIG. 1B, which is more suitable for viewing and which shows much less distortion. For the creation of the rectangular image, only the outer area (2) of the original image (1) if FIG. 1A is used, since it is the only portion of the original image (1) which contains important data. The inner area (3) can be disregarded since it contains only the reflection of the image capture device, and therefore has no contribution to the final image (4).

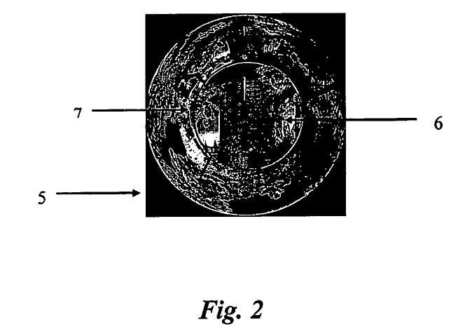

The present invention provides a method and devices for manipulating the inner area (3), to capture an optically zoomed sector, without compromising on the panoramic coverage, and without degradation of the panoramic image, as can be easily appreciated from FIG. 2.

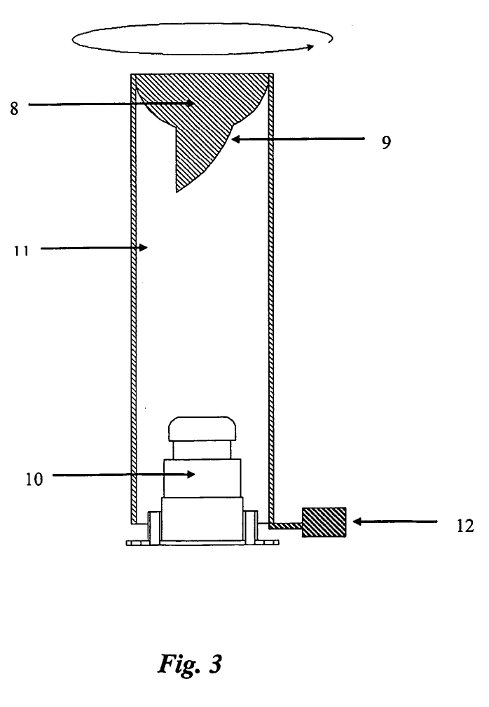

FIG. 2 shows an image that was captured and produced by the panoramic imaging systems with optical zoom capability of FIG. 3, according to the present invention.

In this figure, a circular image, generally indicated at 5, is acquired on the focal plane array of the image capture device, based on the same method of imaging an axisymmetric reflective surface that was described with reference to FIG. 1. The central area (6) of the image (5), where the reflection of the image-capture device previously appeared, is now occupied by an optically zoomed sector. It should be appreciated that the optically zoomed sector may appear also in the panoramic section (7) of the image; however, it will appear there in smaller proportions, due to the unique design of the optical assembly of the invention, as will be easily appreciated by the skilled person from the detailed description of FIGS. 3-7 to follow.

For the creation of a rectangular panoramic image, the same image processing techniques known in the art and referred to above may be used, however the presentation of the optically zoomed sector, requires its extraction and separate presentation.

FIG. 3 is a schematic illustration of a panoramic imaging system with optical zoom capability according to one specific preferred embodiment of the invention. The imaging system comprises a first convex axisymmetric surface (8), coated with reflective material from its convex side. The system further comprises a second reflective surface (9), an image capture device (10), a connector (11) and an optional motor (12).

The first reflective surface (8) is used to reflect a panoramic field of view toward an image capture device (10), which is located coaxially with it and directed towards it. Preferably, the optical axis of the image capture device (10) coincides with the vertical axis of symmetry of the first reflective surface (8). In order to maintain a fixed positioned relationship between the first reflective surface (8) and the image capture device (10), a connector (11), which may be a simple sleeve, is used to fasten the elements in their place. As described with reference to FIG. 1, the axisymmetric reflective surface generates only the outer area of the entire image, and the inner area comprises the reflection of the image capture device.

Referring to FIG. 3, an additional reflective surface (9) is used to reflect a limited sector of the scene toward the center of the image, so that this sector occupies the inner area of the image, which was previously occupied by the reflection of the image-capture device. According to the preferred embodiment shown in FIG. 3, the second reflective surface (9) is connected to the convex side of the first reflective surface (8), preferably around the axis of symmetry of the first reflective surface (8). The main purpose of the second reflective surface (9) is to enable the optical zoom of a specific sector, with respect to the proportions in which the same sector is reflected by the first reflective surface (8). Those skilled in the art of optical design will appreciate that the proper design of the second reflective surface (9), to enable the optical zoom with continuous panoramic coverage, involves several factors: The size of the second reflective surface (9) should be such that it does not prevent the proper imaging of the panoramic field of view that is supposed to be reflected from the first reflective surface (8). The second reflective surface (9) should be tilted to a proper angle, to enable reflection of the sector towards the image capture device (10). The exact location of the second reflective surface (9) should be such that it enables the reflection towards the center of the image, and occupies the area of the image where the reflection of the image capture device previously appeared. Furthermore, the radius of curvature of the second reflective surface (9) should be different than the radius of curvature of the first reflective surface (8) to enable the zoomed reflection. The skilled person will be easily able to provide a reflective surface that is suitable for a particular desired application.

FIG. 3 illustrates a design, which incorporates the second reflective surface (9) to achieve panoramic coverage with optical zoom capability. According to this design the second reflective surface (9) is such that it enables optical zoom at a fixed factor, and once the second reflective surface (9) is designed and fabricated, the zoom factor cannot be changed. Furthermore, the second reflective surface (9) is physically connected to the first reflective surface (8), so that it has a fixed position both in azimuth and in elevation. To enable the rotation of the second reflective surface (9) toward a sector of interest, a motor (12) can be provided. The motor (12) may be connected to the connector (11), in a way that it rotates said connector, and together with it, rotates the first reflective surface (8) and the second reflective surface (9) which are connected to one another. It should be appreciated that the specifications of the motor (12), including the rotation speed and control over the rotation must be selected to be suitable for the desired application, which is within the skill of the routineer. It is further stressed that such motor design and its mechanical interface with the imaging system, are well within the knowledge of those skilled in the art, and therefore no further discussion of the motor design is provided herein.

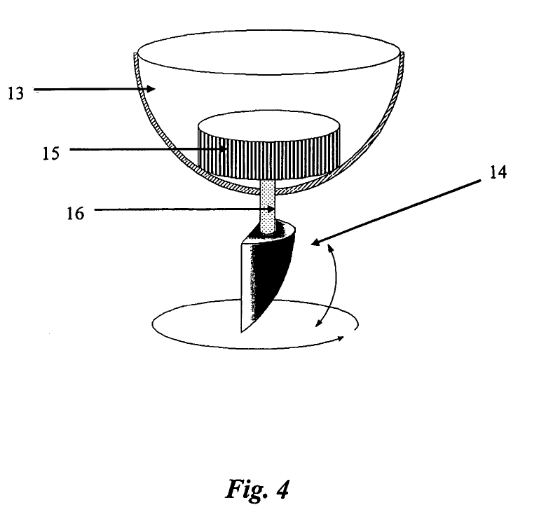

FIG. 3 illustrates the design and main components of an entire imaging system, which enables continuous panoramic imaging together with the imaging of an optically zoomed sector. The optical components of the system, as shown in FIG. 3—namely, the first reflective surface (8) and the second reflective surface (9)—may of course be replaced with several alternative designs, as apparent to the man of the art. FIGS. 4 through 7 illustrate several alternative designs, according to various specific preferred embodiments of the invention. Although these figures describe only the optical components, it will be appreciated by those skilled in the art that those components are part of an entire imaging system, as was described, e.g., with reference to FIG. 3.

FIG. 4 is a schematic illustration of an alternative design of the optical assembly, according to another preferred embodiment of the invention, which enables continuous panoramic coverage together with the optical zoom of a limited sector, at various azimuth and elevation angles. In this figure a first axisymmetric reflective surface (13) is used to reflect a panoramic scene toward an image-capture device positioned coaxially with it. A second reflective surface (14) is used to create an optically zoomed reflection of a limited sector of the scene. The optical properties of the second reflective surface (14) are such that it creates an enlarged reflection of a limited sector in respect to the proportions in which the same sector is reflected by the first reflective surface (13). Selecting suitable optical properties is, of course, within the scope of the skilled person. The second reflective surface (14) is placed at the convex side of the first reflective surface (13), around the vertical axis of symmetry of the first reflective surface (13). A hole is provided at the center of the first reflective surface (13), to enable the attachment of the second reflective surface (14) to a motor (schematically shown at 15) located at the concave side of the first reflective surface (13). A connector (16) connects the motor (15) with the second reflective surface (14) through said hole. The motor (15) controls the rotation, elevation and depression of the second reflective surface (14), to enable the positioning of the second reflective surface (14) in the desired direction, and thus the zooming-in on a sector of interest.

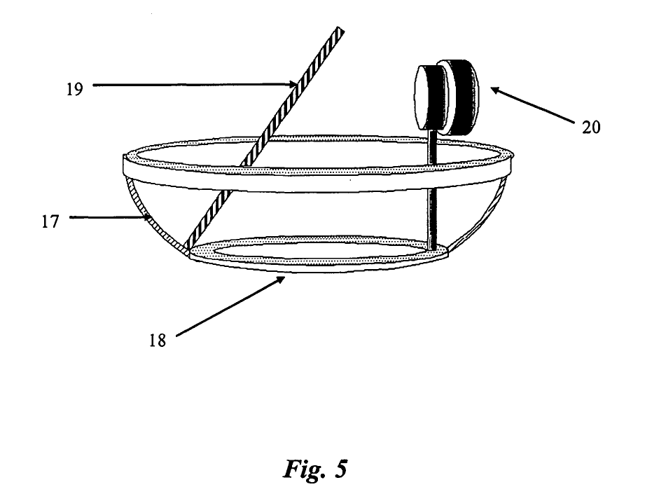

FIG. 5 is a schematic description of an optical assembly according to another preferred embodiment of the invention, which enables panoramic coverage with enhanced optical zoom capability of a limited sector. The optical assembly comprises a first convex axisymmetric reflective surface (generally indicated at 17), used to reflect the panoramic scene toward an image-capture device positioned coaxially with it. A hole (18) is provided at the center of the first reflective surface (17), around its vertical axis of symmetry. A second reflective surface (19) is placed at the concave side of the first reflective surface (17). The second reflective surface (19) is designed to reflect a limited sector toward the hole (18), in order to enable the imaging of that sector at the center of the image. Said second reflective surface (19) is fastened to the axisymmetric surface from its concave side with suitable connectors (not shown). The optical properties of the second reflective surface (19) are such that it creates an enlarged reflection of a limited sector with respect to the proportions in which the same sector is reflected by the first reflective surface (17). Apart from the second reflective surface (19), a lens assembly (20) may be positioned between the sector and the second reflective surface (19). The lens assembly (20) is designed to control the zoom factor, and permits to enhance the zoom factor beyond the factor which derives from the design of the second reflective surface (19). Several positions are possible for the lens assembly (20). The entire lens assembly (20) may be positioned between the second reflective surface (19) and the sector that is imaged. Alternatively, the lens assembly (20) may be positioned between the second reflective surface (19) and the hole (18). The lens assembly (20) may also be divided into separate lenses, which are positioned both between the hole (18) and the second reflective surface (19), and between the second surface (19) and the sector.

The lens assembly (20) may comprise a single magnifying lens or several lenses, designed to cooperatively enlarge a limited sector of the scene. An optional motor may be incorporated in the system. The motor may be positioned, e.g., within the concave side of the axisymmetric reflective surface, connected to the second reflective surface and to the lens assembly, and designed to rotate solely the second reflective surface together with the lens assembly.

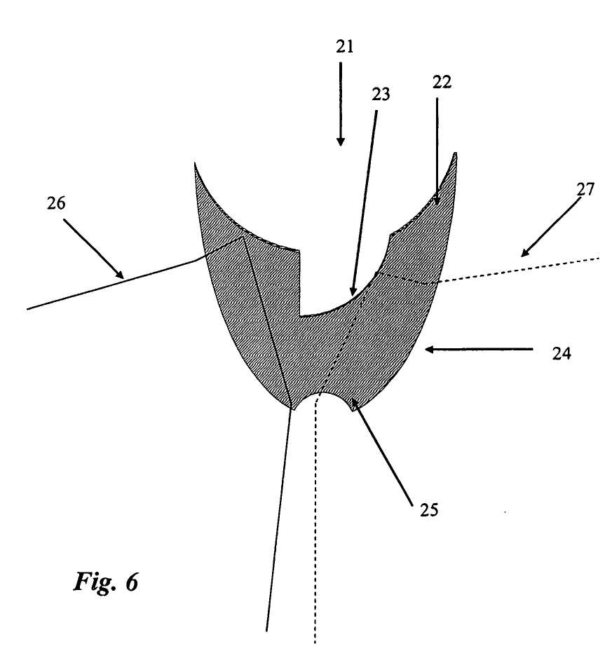

FIG. 6 is a schematic description of the design of a monolithic panoramic lens, according to a preferred embodiment of the invention, which incorporates an optical zoom lens from within. The design described in FIG. 6 also exploits the use of reflective surfaces to capture the scene. According to this preferred embodiment of the invention, a single solid material is used to fabricate the lens (generally indicated by numeral 21). The shape of the lens (21) is essentially axisymmetric, except for the portion designed to operate as a zoom.

The monolithic lens (21) comprises several surfaces:
An upper concave axisymmetric surface (22), coated with reflective material from its exterior concave side, designed to reflect rays from a panoramic field of view;
A zooming surface (23), extending into the monolithic lens through the upper surface (22), having a radius of curvature different from the radius of curvature of the upper surface (22). The zooming surface (23) is coated with reflective material from its exterior, and designed to magnify and reflect rays from a limited sector;
A transparent perimeter surface (24), designed to refract rays penetrating the lens; and
A transparent lower convex surface (25), designed to refract rays exiting the lens.

All curvatures of all; surfaces in the lens (21) are designed to compensate aberrations and distortions which are created by the refractions and reflections.

Reference is now made to the optical paths of light rays, illustrated in FIG. 6, which are reflected by the lens (21). It should be emphasized that the optical paths shown in the figure are of representative rays that are reflected by each surface. It should further be appreciated that the paths shown in the figure are schematic and designed for a general illustration of the concept only.

A first ray (26), originating at the panoramic scene, hits the perimeter refractive surface (24) and penetrates the lens (21). The first ray (26) then travels through the lens (21) and is reflected by the upper reflective surface (22) downwards, toward the lower refractive surface (25). The first ray (26) is then refracted by the lower refractive surface (25) and exits the lens (21). A second ray (27), originating at a sector which is covered by the zooming surface (23), is refracted by the perimeter refractive surface (24) and penetrates the lens (21). The second ray (27) then travels through the lens (21), hits the zooming surface (23) and is reflected downwards towards the lower refractive surface (25). The ray (27) then hits the lower refractive surface (25), where it is refracted and exits the lens (21).

The vertical field of view which is covered by each of the reflective surfaces and the horizontal field of view covered by the zooming mirror (23) will of course vary, subject to the precise optical design desired for each specific application.

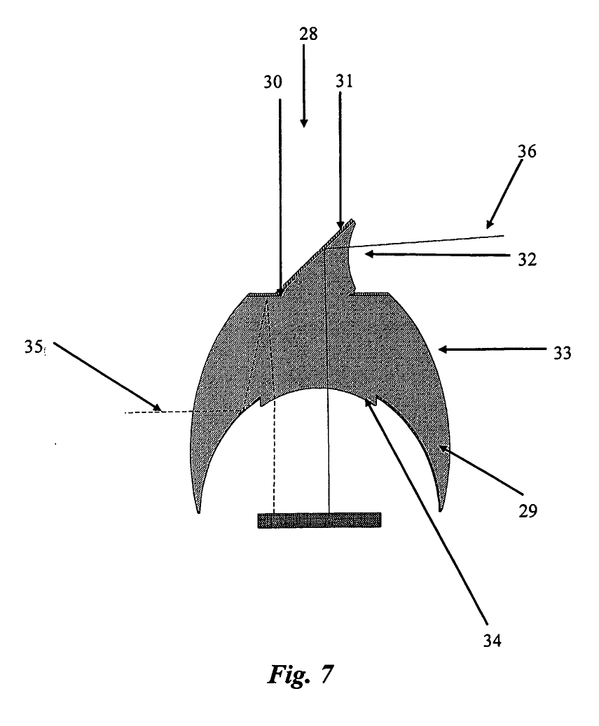

FIG. 7 is a schematic illustration of a monolithic panoramic lens (generally indicated by numeral 28) which incorporates an optical zoom lens from within, according to an alternative preferred embodiment of the invention. According to this design, a single solid material is used to fabricate the lens (28). The shape of the lens (28) is essentially axisymmetric, except for the portion designed to operate as a zoom.

The monolithic lens (28) comprises several surfaces:
A lower convex axisymmetric surface (29), coated with reflective material from its exterior, designed to reflect rays from a panoramic scene;
An upper axisymmetric surface (30), coated with reflective material from its exterior;
A zooming surface (31), extending out from the upper surface (30), coated with reflective material from its exterior, designed to magnify and reflect rays from a limited sector;
A transparent upper refractive surface (32), designed to refract rays from a limited sector, before being reflected by the zooming surface (31);
A transparent perimeter refractive surface (33), designed to refract rays penetrating the lens (28); and
A transparent lower refractive surface (34), designed to refract rays exiting the lens (28).

All curvatures of all surfaces in the lens are designed to compensate aberrations and distortions which are created by the refractive and reflective surfaces.

Reference is now made to the optical paths of light rays, schematically illustrated in FIG. 7, which are reflected by the lens (28). It should be understood that the optical paths shown are of representative rays that are reflected by each surface. Of course, the paths shown in the figure are schematic and are solely meant for a general illustration of the concept.

A first ray (35), originating at the panoramic scene, hits the perimeter refractive surface (33) and penetrates the lens (28). The first ray (35) then travels through the lens (28) and is reflected by the lower convex reflective surface (29) upwards toward the upper reflective surface (30). The first ray (35) is then reflected by the upper reflective surface (30) downwards, toward the transparent lower refractive surface (34), and exits the lens (28).

A second ray (36), originating at a sector which is covered by the zooming surface (31), is refracted by the transparent upper refractive surface (32). The second ray (36) then travels through the upper section of the lens, hits the zooming surface (31) and is reflected downwards toward the lower refractive surface (34). The ray (36) then hits the lower refractive surface (34), where it is refracted and exits the lens (28).

The vertical field of view which is covered by each of the reflective surfaces and the horizontal field of view covered by the zooming mirror (31) may of course vary, subject to the precise optical design desired for each specific application.

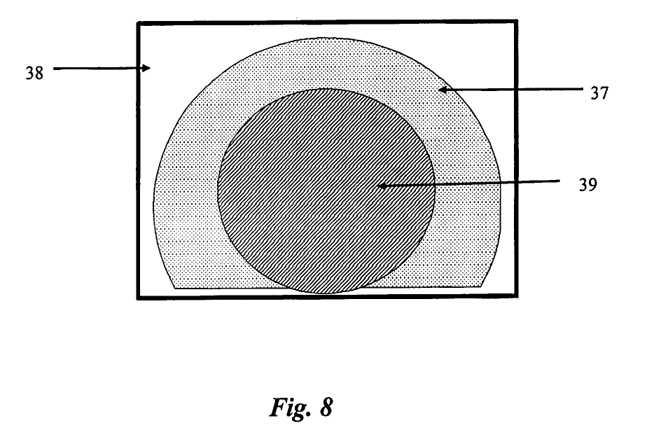

FIG. 8 illustrates a method of capturing an almost panoramic image with enhanced resolution and optical zoom capability.

In all designs shown in FIGS. 3-7, the panoramic lens was preferably positioned coaxially with the image capture device, and the image capture device was preferably set to capture all—and no more than—the image that reflects from the reflective lens. Such setting causes the image to occupy the area of the focal plane array, as was illustrated in FIG. 1. Since most common focal plane arrays are rectangular, having a non-square resolution, an image that reflects from an axisymmetric lens, does not occupy the entire area of the focal plane array. Although the entire panoramic scene is captured, this is done while compromising the image resolution and leaving large portions of the focal plane array unused.

Many applications exist, where an entire panoramic coverage is not necessary, and a wide angle between 180 degrees and 270 degrees can be sufficient. For that purpose, the image-capture device does not have to be positioned coaxially with the reflective lens, and does not have to be set to capture the entire image that is reflected from the lens.

According to the particular preferred embodiment of the present invention illustrated in FIG. 8, the image capture device is set to capture roughly 270 degrees of the panoramic image (37) that reflects from the reflective lens. The image capture device is set so that the image extends through the entire width and length of the focal plane array (generally indicated at 38). The optically zoomed sector (39) will continue to appear at the center of the image. According to this method, most of the focal plane array (38) is used and enhanced resolution is achieved both in the almost-panoramic scene (37) and in the optically zoomed sector (39).

All the above description of preferred embodiments of the invention has been provided only for the purpose of illustration, and is not meant to limit the invention in any way. Many modifications can be made to the various systems, elements and lenses, as well as to their relationships, for many different uses and needs, all without exceeding the scope of the claim.

1. An imaging assembly comprising a first, essentially symmetric reflective surface, having a shape suitable to reflect a substantially panoramic view of an area surrounding it, and a second reflective surface, which is asymmetric with respect to said first reflective surface, viz., which is positioned, with respect to the axis of symmetry of said first reflective surface, such that its movement in one or more directions reflects different portions of the area reflected by said first reflective surface, wherein the optical properties of said second reflective surface are such that area imaged by it is magnified with respect to the same portion of the area imaged by the first reflective surface.

2. An imaging assembly according to claim 1, comprising:
a. A first convex reflective surface having a vertical axis of symmetry;
b. A second reflective surface, having a first edge and a second edge, located around said vertical axis of symmetry of said first convex reflective surface, having a tilted position in respect to said vertical axis of symmetry of said first convex reflective surface, said second reflective surface having a radius of curvature different from the radius of curvature of said first convex reflective surface;
wherein light from a first 360 degrees panoramic scene is reflected by said first convex reflective surface, and light from a second scene is reflected by said second reflective surface.

3. An imaging assembly according to claim 1, further comprising an image capture device, directed toward said first convex reflective surface.

4. An imaging assembly according to claim 3, wherein the image capture device has an optical axis coinciding with the vertical axis of symmetry of said first convex reflective surface, said image capture device being set to capture the entire image that is reflected from said first convex reflective surface and the entire image that is reflected from said second reflective surface.

5. An imaging assembly according to claim 3, wherein the image capture device has an optical axis which is parallel to the vertical axis of symmetry of said first convex reflective surface, said image capture device being set to capture a part of the image that is reflected from said first convex reflective surface and the entire image that is reflected from said second reflective surface.

6. An imaging assembly according to claim 3, further comprising a connector having a first edge connected to said first convex reflective surface, and a second edge connected to said image-capture device, wherein optical transparency exists between said first edge and said second edge, allowing light arriving from the direction of said first edge to reach said image-capture device essentially without distortion.

7. An imaging assembly according to claim 1 wherein the first edge of the second reflective surface is connected to the first convex reflective surface.

8. An imaging assembly according to claim 1 wherein a hole is formed in the first convex reflective surface and around its vertical axis of symmetry.

9. An imaging assembly according to claim 8, further comprising a motor, located at the concave side of the first convex reflective surface, connected to the second reflective surface, through said hole.

10. An imaging assembly according to claim 8, comprising a motor designed to control the rotation of the second reflective surface.

11. An imaging assembly according to claim 8, comprising a motor designed to control the depression and elevation of the second reflective surface.

12. An imaging assembly according to claim 6, further comprising a motor, connected to said connector, designed to control the rotation of said imaging assembly.

13. An imaging assembly according claim 6, further comprising a motor, connected to the image capture device, designed to control the rotation of said imaging assembly.

14. An imaging assembly according to claim 8, wherein the second reflective surface is located at the concave side of the first convex reflective surface, directed to reflect a second scene through said hole.

15. An imaging assembly according to claim 14, further comprising an optical assembly, designed to control the magnification factor of the second scene, said optical assembly incorporating the second reflective surface and optical lenses.

16. An optical assembly according to claim 15, wherein said optical lenses are located between said second reflective surface and said second scene.

17. An optical assembly according to claim 15, wherein said optical lenses are located between said second reflective surface and said hole.

18. An imaging assembly according to claim 15, further comprising a motor, located at the concave side of the first convex reflective surface, connected to said optical assembly.

19. An imaging assembly according to claim 18, comprising a motor designed to control the rotation of said optical assembly.

20. An imaging assembly according to claim 18, comprising a motor designed to control the depression and elevation of said optical assembly.

21. An imaging assembly according to claim 1, which is a monolithic lens in which the second reflective surface, which is asymmetric with respect to the first reflective surface, is integral with said first, essentially symmetric reflective surface, such that the rotation of said first reflective surface around its axis of symmetry causes said second reflective surface to reflect different portions of the area reflected by said first reflective surface.

22. An imaging assembly according to claim 21, wherein the second reflective surface extends into the monolithic lens through its upper surface and has a radius of curvature different from the radius of curvature of said upper surface, and wherein said second reflective surface is coated with reflective material from its exterior.

23. An imaging assembly according to claim 21, wherein an axisymmetric transparent refractive surface is provided in the first reflective surface around its axis of symmetry, said imaging assembly further comprising a third reflective surface suitable to reflect the panoramic image, which is reflected toward it by the first reflective surface, toward said axisymmetric transparent reflective surface.

24. An imaging assembly according to claim 23, wherein the second reflective surface which extends out from the third reflective surface is coated with reflective material from its exterior, and is set to reflect an image toward said axisymmetric transparent refractive surface.

25. (canceled)
